(19) United States
(12) Patent Application Publication
(10) Pub. No.: US 2026/0079387 A1
(43) Pub. Date: Mar. 19, 2026

(54) PROJECTOR SYSTEM

(71) Applicant: Andrew JONES, Wales (GB)

(72) Inventor: Andrew JONES, Wales (GB)

(21) Appl. No.: 19/317,526

(22) Filed: Sep. 3, 2025

(30) Foreign Application Priority Data
Sep. 3, 2024 (GB) 2412881.1

(51) Int. Cl. G03B 21/20; G02B 30/56; G03B 21/14; G03B 29/00; H04M 1/02

(52) U.S. Cl. CPC G03B 21/2066; G02B 30/56; G03B 21/145; G03B 29/00; H04M 1/0272

(57) ABSTRACT

The present invention relates to a projector system comprising: a housing comprising: a lower portion comprising: a base for positioning on a contact surface; and a projector positioned to project a projected light source outwardly from the base; and an upper transparent portion comprising: a semi-transparent or transparent, planar reflective surface spaced apart from the projector and positioned to receive the projected light source from the projector thereon, in which the semi-transparent or transparent, planar reflective surface extends at an angle to an axis defined by the projected light source to produce a floating image within the upper transparent portion of the housing.

### FIELD OF THE INVENTION

The present invention relates to a projector system, and in particular an adaptable projector system for producing predetermined floating images.

### BACKGROUND

It is important to encourage young people to learn to read and to have an enjoyment for storytelling and books. One way to encourage the joy of reading is to capture a reader's imagination. Some young readers can struggle with short attention spans and learning difficulties which may make the traditional way of learning to read difficult.

There is therefore a need for a device which is able to captivate a young person's attention when listening to stories or reading books.

### Prior Art

Korean patent application KR 10-2628753 (Marketon Inc) discloses a mobile hologram device.

Chinese patent application CN 217333008 (Henan Yunji Shuwen Information tech Co ltd) discloses a micro-scene mixed reality 3D display system and a method for controlling its operation.

United states patent application US 2022/0244681 (Gregory Kirkorowicz) discloses a holographic projection assembly for projecting a holographic image of a person. A hologram emitter is integrated into the housing and a hologram emitter projects a hologram outwardly from the housing when the hologram emitter is turned on. A speaker is integrated into the housing to emit audible sound outwardly from the housing.

U.S. Pat No. 6,409,351 (Ligon) discloses a projection system that has a convex reflecting mirror to disperse a projected image onto an inner translucent surface of a screen enclosing a spherical or other three-dimensional space.

Chinese patent application CN 1287628 (Hiller et. al.) discloses a projector and projector system of a deflecting mirror.

### SUMMARY OF THE INVENTION

According to a first aspect of the present invention, there is provided a projector system comprising:
a housing comprising:
a lower portion comprising:
a base for positioning on a contact surface; and
a projector positioned to project a projected light source outwardly from the base; and
an upper transparent portion comprising:
a semi-transparent or transparent, planar reflective surface spaced apart from the projector and positioned to receive the projected light source from the projector thereon, in which the planar reflective surface extends at an angle to an axis defined by the projected light source to produce a floating image within the upper transparent portion of the housing.

The projector projects the projected light to a semi-transparent or transparent, planar reflective surface which is held at an angle with respect to the light source, so that the semi-transparent or transparent planar reflective surface reflects the projected light towards a user such that projected light creates an illusion (Pepper's Ghost illusion) so that the image projected appears to float in front of the user.

It is appreciated that in some embodiments the projector may be any means to project an image, such as an electronic device. This may include a smart phone with an image or animation displayed on the screen.

The planar reflective surface is semi-transparent or transparent so that the planar reflective surface does not appear to be visible within the upper portion and only the projected image appears visible due to reflection by the angled planar reflective surface that receives the projected image.

In a preferred embodiment the planar reflective surface is semi-transparent to reduce glare and spurious reflections so that the projected image is clearer. For example, the planar reflective surface may have an anti-reflective coating.

As the projected light is reflected on the semi-transparent or transparent planar reflective surface that is within the transparent upper the projected light appears to float within a void between the upper and lower portions.

The semi-transparent or transparent planar reflective surface preferably extends at an angle of at least 10 degrees, preferably at least 30 degrees, and ideally at 45 degrees to an axis defined by the projected light source. In this way light is directed towards the angled planar reflective surface and is reflected by the angled planar surface. The projected and subsequently reflected light creating an illusion that the image or animated image that is viewed by a user at an appropriate viewing angle appears to float within the upper transparent portion.

In a preferred embodiment the plane of emission of light from the projector is at 45 degrees to the plane of the planar reflective surface is at 45 degrees with respect to the plane of emission of light. The optional viewing angle of the reflected image is at 45 degrees to the planar reflective surface.

The reflected image (light) is enhanced when the contrast is greatest with the immediate surroundings or background. Therefore, the projector system generates a bright image when viewed in darkness or low levels of light.

The semi-transparent or transparent planar reflective surface is arranged in a volume defined by the lower portion and the upper portion. In this way the image is displayed within the projector system and is not projected beyond the upper and lower portions.

Preferably the upper transparent portion is dome shaped and the image is therefore displayed with the dome, appearing as being within a crystal ball.

The system preferably further comprises an audio system configured in use to play sound, such as discrete series of sounds, or continuous sounds, for example a story spoken by a narrator or a music track or some other form of broadcast.

In this way the system can provide a storytelling means with visual and/or audio elements.

In one embodiment, the audio system is configured in use to play sound in response to the projected light source provided by the projector.

The floating image is preferably an animated image such a film or movie clip or a digital file, for example from a web-based platform, and in a digital video format such as WebM, MPEG, 3GP or AVI.

The system preferably further comprises a controller operable to control one or more of: the projector and/or the audio system; including to control image brightness, play, pause, fast-forward, skip and rewind (for a video track) and volume, bass, and treble (for a sound track).

The controller may be located on or within the lower portion of the housing. The controller may comprise one or more push buttons for use by an operator. For example, the controller may comprise one or more push buttons for: stopping the sound and/or projection of the light source; for replaying the sound and/or projection of the light source; for altering the volume of the sound; and or for altering the brightness and/or colours of the projected light source.

In a preferred embodiment the projector system includes a printed circuit board (PCB) with a microcontroller operatively connected to control buttons, the projector and one or more loudspeaker.

The buttons may be backlit to assist with identification as it may often be preferable to use the projector system in low light or darkness so that the image(s) shown are bright.

The lower portion may further comprise a slot configured in use to receive a card comprising a unique identifier, and in which the system further comprises a processor configured in use to control one or more of: the projected light source produced by the projector and/or the sound produced by the audio system on identification of the unique identifier of a card received within the slot.

The unique identifier may be a barcode or near field communication (NFC) device or tag.

Each unique identifier may be associated with a different story or book. In this way the card is inserted into a slot in the housing that has a reader to read the card, and the processor controls the light source from the projector and/or sound produced by the audio system to tell a story with visual and audible elements from the projector system.

In one embodiment the projector system has a device to access a portal via an internet connection to obtain image data and/or audio data relating, for example to a story or book, so that the data can be streamed. For example, the reader may access a portal via an Internet connection.

In one embodiment the data may be transmitted to the projector system from a wireless transmitter, such as a wi-fi device, an electronic communication device such as a smart phone, tablet, or a smart speaker. In this embodiment the projector system includes a suitable wireless receiver for receiving the data and a memory which acts as a buffer for storing, or buffering data, prior to replaying sound data through the loudspeaker or audio system.

The projector may be configured in use to provide a series of images and/or in which the audio system is configured in use to provide a series of sounds. The audio system preferably includes a loudspeaker or comprises a set of headphones or an earpiece.

The projector system may have its own a power source to provide power to the projector (and optionally the controller). The power source may be a battery, for example a rechargeable battery. Alternatively, or in addition to the battery, the projector system may be fitted with a suitable adapter for connection to a mains or other type of electricity supply.

In some embodiments the projector system includes a timer so that the image and/or audio may play and/or stop at predetermined times or may play for a predetermined time period.

According to a second aspect of the present invention, there is provided a projector system card for use with a projector system as herein described, in which the card comprises a unique identifier corresponding to a particular floating image and/or sound, or series thereof.

A preferred embodiment of the invention will now be described, by way of example only, and with reference to the Figures in which:

### BRIEF DESCRIPTION OF FIGURES

FIG. 1 shows a schematic illustration of a perspective front view of a projector system according to one embodiment of the present invention;

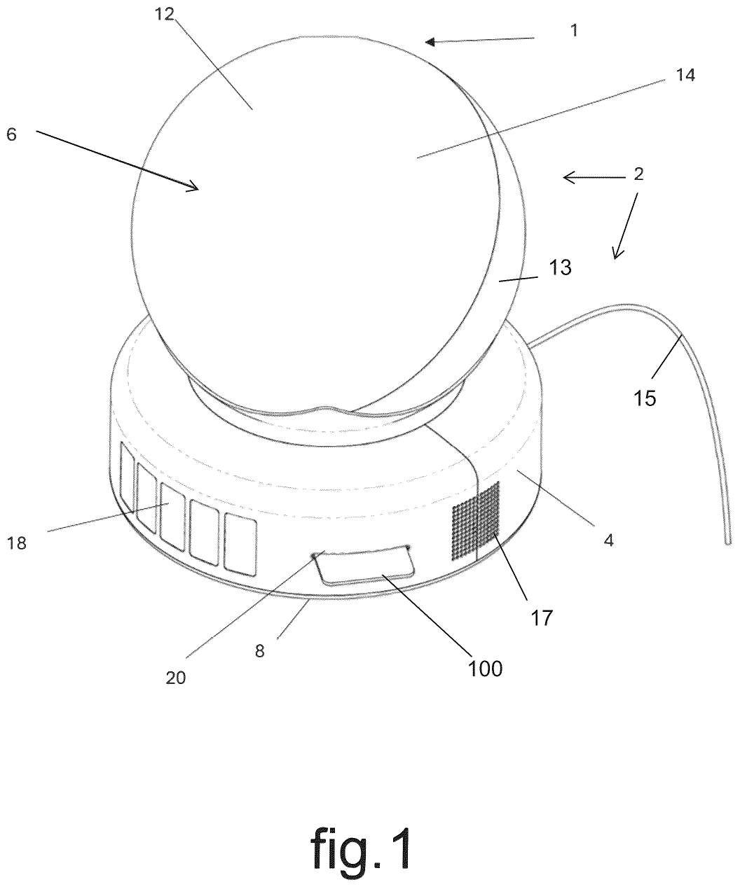

FIG. 2 shows a schematic illustration of a perspective rear view of the projector system of FIG. 1; and

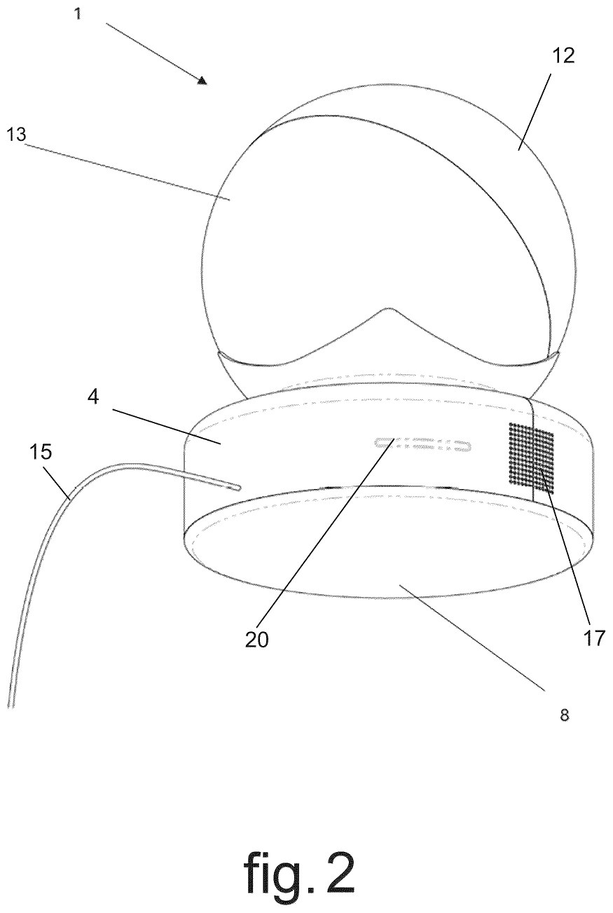

FIG. 3 shows a schematic illustration of an exploded front view of the projector system of FIG. 1.

### DETAILED DESCRIPTION OF FIGURES

With reference to the Figures, there is provided a projector system 1 comprising a housing 2 comprising a lower portion 4 and an upper portion 6.

The lower portion 4 comprises a base 8 for positioning on a contact surface; and a projector 10 positioned adjacent the base 8 to project a projected light source outwardly from the base 8.

In other embodiments not shown, the lower portion may be configured to hold the projector at an angle with respect to the contact surface (such as a table). For example, the lower portion may be wedge shaped. In this way the viewing angle can be adjusted for easier viewing.

The upper portion 6 is formed from two parts 12, 13 mounted on the lower portion 4. The upper part 12 of the upper portion is dome shaped. The lower part 13 of the upper portion 6 is substantially dome shaped, having an opening 13A for the projector 10.

The two parts 12, 13 are transparent. Together these parts 12, 13 form a substantially spherical transparent upper part 6 which defines a cavity 14.

The upper portion 6 formed from the two parts 12, 13 further comprises a semi-transparent or transparent, planar reflective surface 16 mounted within the cavity 14 and spaced apart from the projector 10 and positioned to receive the projected light source from the projector 10 thereon.

In the pictured embodiment the semi-transparent or transparent, planar reflective surface 16 is arranged across where the upper part 12 and lower part 13 are joined to form the transparent sphere 6. The planar reflective surface 16 is at an angle with respect to the projector 10. The projected light source is reflected by the planar reflective surface 16 to produce a floating image (for example an animated image) which appears within the upper transparent portion 6 (formed from parts 12, 13) of the housing 2.

The projector system 1 further comprises an audio system (not shown) with a loudspeaker 17 configured in use to play sound. The audio system is configured in use to play sound in response to the projected light source provided by the projector 10.

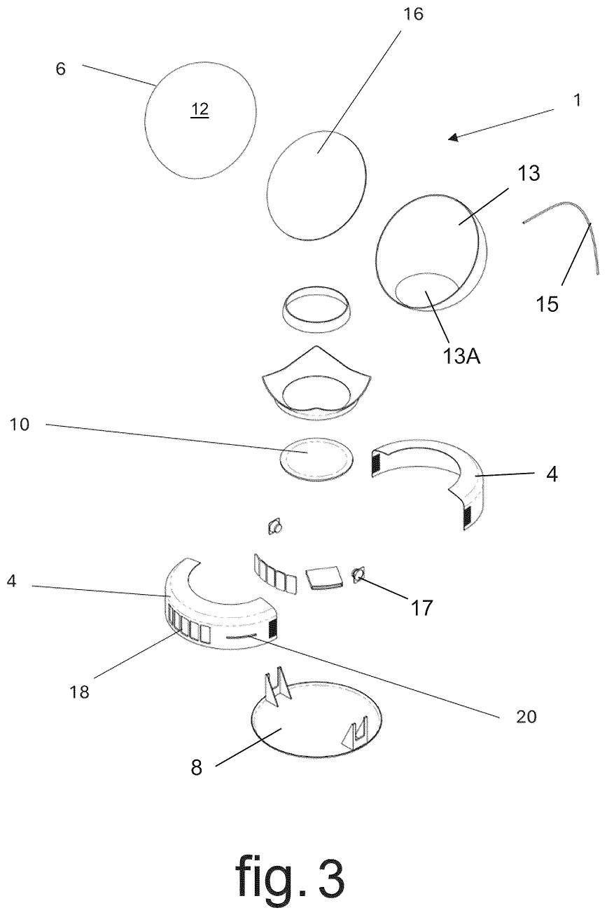

The projector system 1 further comprises a controller 18 operable to control one or more of: the projector 10 and/or the audio system. The full components of the controller 18 are not shown in the exploded view (FIG. 3) of pictured embodiment but it is appreciated that the before mentioned parts are operatively connected to each other and to a power supply.

The controller 18 is located on the lower portion 4 of the housing 2. The controller 18 has a selection of buttons.

The lower portion 4 further comprises a slot 20 configured in use to receive a card comprising a unique identifier (such as for example a barcode or NFC tag). Each unique identifier may be associated with a different story or book.

The system 1 further comprises a processor (not shown) that is in communication with the controller and is configured in use to control one or more of: the projected light source produced by the projector 10 and/or the sound produced by the audio system on identification of the unique identifier of a card received within the slot 20.

In use, the user select a predetermined card and inserts the card 100 into slot 20. The processor identifies the unique identifier of the card and operates the projector 10 to project the predetermined light source as determined from the unique identifier; and operates the audio system to produce the required predetermined sound as determined from the unique identifier.

The projector system 1 is connected to a power supply by means of a cable 15.

The projector system 1 therefore helps to bring a story or book to life by simultaneously providing floating images and sound to provide a captivating visual and audio display to capture the user's attention.

The invention has been described by way of examples only and it will be appreciated that variation may be made to the above-mentioned embodiments without departing from the scope of protection as defined by the claims.

1. A projector system comprising:
a housing comprising:
a lower portion comprising:
a base for positioning on a contact surface; and
a projector positioned to project a projected light source outwardly from the base; and
an upper transparent portion comprising:
a semi-transparent or transparent, planar reflective surface spaced apart from the projector and positioned to receive the projected light source from the projector thereon, in which the planar reflective surface extends at an angle to an axis defined by the projected light source to produce a floating image within the upper transparent portion of the housing.

2. A projector system as claimed in claim 1, further including an audio system configured in use to play sound.

3. A projector system as claimed in claim 2, in which the audio system is configured in use to play sound in response to the projected light source provided by the projector.

4. A projector system as claimed in claim 1, in which the floating image is an animated image.

5. A projector system as claimed in claim 1, further comprising a controller operable to control one or more of: the projector and/or the audio system.

6. A projector system as claimed in claim 5, in which the controller is located on the lower portion of the housing.

7. A projector system as claimed in claim 1, in which the lower portion further comprises a slot configured in use to receive a card comprising a unique identifier, and in which the system further comprises a processor configured in use to control one or more of: the projected light source produced by the projector and/or the sound produced by the audio system on identification of the unique identifier of a card received within the slot.

8. A projector system as claimed in claim 7, in which the unique identifier is a barcode or NFC tag.

9. A projector system as claimed in claim 1, in which the projector is configured in use to provide a series of images and/or in which the audio system is configured in use to provide a series of sounds.

10. A projector system as claimed in claim 1, including a timer.

11. A projector system as claimed in claim 1 including a device to access a portal via an internet connection to obtain image data and/or audio data.

12. A projector system as claimed in claim 2 including a wireless transmitter for transmitting data to a wireless receiver and a memory which acts as a buffer for storing, or buffering data, prior to replaying sound data through a loudspeaker or audio system and/or image data by means of the projector.

13. A projector system card for use with a projector system as claimed in claim 1, in which the card comprises a unique identifier corresponding to a particular floating image and/or sound, or series thereof.

14. A projector system according to claim 1 wherein the projector is a smartphone.

15. A projector according to claim 1 wherein the lower portion is wedge shaped.
